(19) United States
(12) Patent Application Publication
(10) Pub. No.: US 2008/0134466 A1
(43) Pub. Date: Jun. 12, 2008

(54) Integrally molded hinge assembly and method of manufacturing the same

(75) Inventor: Michael A. Massengill, Warren, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/637,259

(22) Filed: Dec. 11, 2006

(51) Int. Cl. E05D 5/10; E05D 11/00

(52) U.S. Cl. 16/222; 16/386

(57) ABSTRACT

A hinge structure (10) comprises a single molded swivel hinge (12) molded initially as a unitary structure having a first portion (14) and a second portion (16). The first portion (14) includes first and second hinge pins (24, 26) extending in opposed directions from a base member (38). The second portion (16) includes hinge pin receiving portions (34, 36), the first and second hinge pins (24, 26) having an associated hinge pin receiving portion (34, 36), each hinge pin receiving portion being molded to result in a cylindrical bore (28, 30) after initial operation of the hinge structure (10). The first and second hinge pins (24, 26) are triangular in shape over its extent within its associated hinge pin receiving portion (34, 36).

### TECHNICAL FIELD

The present invention is directed to an integrally molded hinge assembly that includes a three-point hinge joined to a swivel member and a base member and method of manufacturing the integrally molded hinge assembly.

### BACKGROUND OF THE INVENTION

A known hinge comprises an assembly of parts made of plastic or metal. The components of the hinge assembly are separately manufactured and typically made from plastic or metal and are assembled together after fabrication. There is a need for a hinge assembly which consists of a minimum number of components and which can be produced without manual assembly of individual parts.

### SUMMARY OF THE INVENTION

In accordance with one example embodiment of the present invention, a hinge structure comprises a single molded swivel hinge molded initially as a unitary structure having a first portion and a second portion. The first portion includes first and second hinge pins extending in opposed directions from a base member. The second portion includes hinge pin receiving portions, the first and second hinge pins having an associated hinge pin receiving portion, each hinge pin receiving portion being molded to result in a cylindrical bore after initial operation of the hinge structure. The first and second hinge pins are triangular in shape over its extent within its associated hinge pin receiving portion.

In accordance with another example embodiment of the present invention, a hinge assembly is integrally molded from a single operation comprising a hinge member having at least one three-point triangular shaped pin integrally molded and fixedly extending from the hinge member. The hinge member is made from a material. The hinge assembly also includes a swivel member having at least one cylindrical housing circumscribing and having an integrally molded connection with the three-point triangular shaped pin such that initial rotation of the swivel member with respect to the base member breaks the integrally molded connection providing a rotatable attachment between the cylindrical housing and the three-point triangular shaped pin. The swivel member is made from the same material as the hinge member during a single molding operation.

In accordance with yet another example embodiment of the present invention, a method of making an integrally molded hinge assembly comprises the steps of providing a mold having cavities for forming an integrally molded hinge assembly that includes a base member and a swivel member. The method also includes the steps of inserting a first and a second set of side tooling into the mold to a prescribed distance, injecting material into the mold through at least one port, and filling the cavities with the material. The method further includes the steps of forming an integral connection between the base member and the swivel member and withdrawing the side tooling from the mold creating voids between the base member and the swivel member to enable relative movement therebetween.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of an integrally molded hinge assembly constructed in accordance with one example embodiment of the invention;

FIG. 2 is a side view of an integrally molded hinge assembly constructed in accordance with one example embodiment of the invention used in a particular example application;

FIG. 3 is a side view of the integrally molded hinge assembly of FIG. 1;

FIG. 4A is a dynamic side view of the integrally molded hinge assembly of FIG. 1, moving from a first to a second position;

FIG. 4B is a magnified dynamic partial side view of the integrally molded hinge assembly of FIG. 4A;

FIG. 5 is a plan view of the integrally molded hinge assembly of FIG. 1;

FIG. 6 is an elevated view of the integrally molded hinge assembly of FIG. 1; and

FIG. 7 is a partial perspective view of a molding process of an integrally molded hinge assembly constructed in accordance with one example embodiment of the invention.

### DETAILED DESCRIPTION

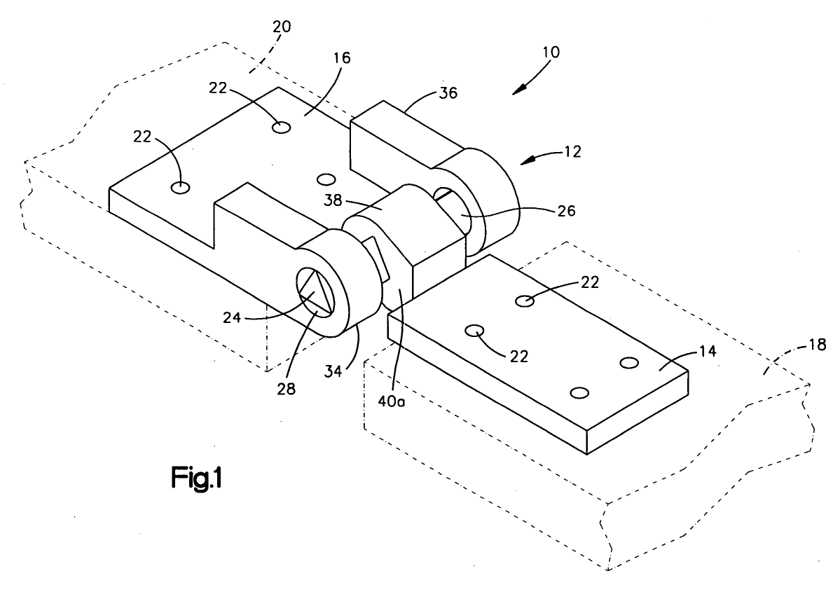

Referring to FIG. 1, an integrally molded hinge assembly 10, in accordance with a first example embodiment of the invention, is shown. The integrally molded hinge assembly 10 includes a hinge structure 12 that attaches a base element 14 and swivel element 16. The hinge assembly 10 is made of a material suitable for molding and is molded into an assembled integral unit by an in-mold assembly process. Such suitable material for the integrally molded hinge assembly could include, but is not limited to, thermoplastic polymers, metals, metal alloys, and/or any combination thereof. The molding of the materials including metals and metal alloys could be achieved in a die cast process, while thermal plastics could be used to form the integrally molded hinge assembly through, for example an injection molding process. Some examples of suitable thermoplastic polymers are polythalamide, nylon 6, nylon 66, nylon 46, Polyphenylene sulfide (PPS), Polyoxymethylene (POM), Polypropylene (PP), and Polybutylene terephthalate (PBT).

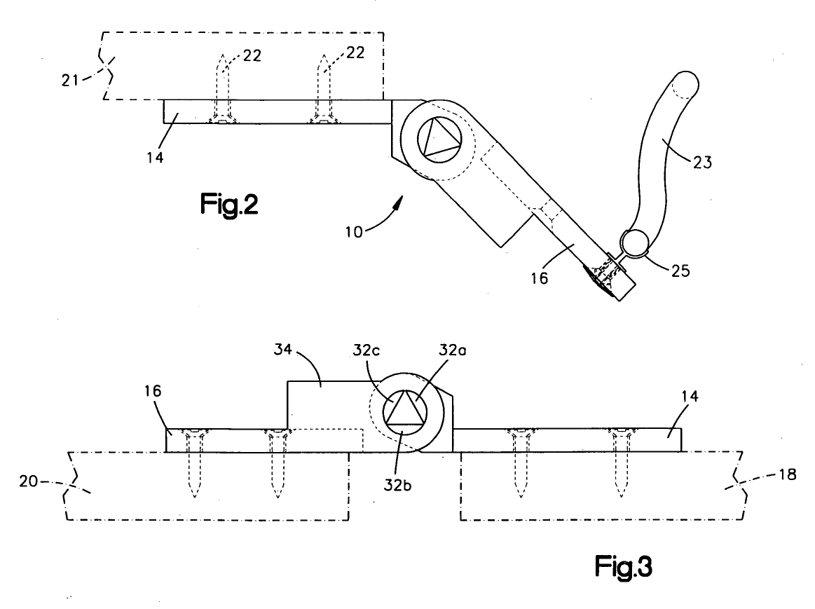

The base element 14 and swivel element 16 are attachable to first and second structures 18 and 20, respectively, using a plurality of fasteners 22. Alternatively, an adhesive could be used to attach the base 14 and swivel 16 elements to first and second structures 18, 20, or a combination of adhesive and fasteners could be used for attachment. The first and second structures, 18, 20 represent planer surfaces, but could be any shape or object requiring a swivel hinge connection for joining two structures for relative pivotal movement without departing from the spirit and scope of the claimed invention. In one example embodiment, the integrally molded hinge assembly 10 is used for attaching a brake line to a chassis of a motor vehicle, as depicted in FIG. 2. The base element 14 is secured by fasteners 22 to the underside of a vehicle 21 and a vehicle brake line 23 is supported by a clip 25 attached to the swivel element 16.

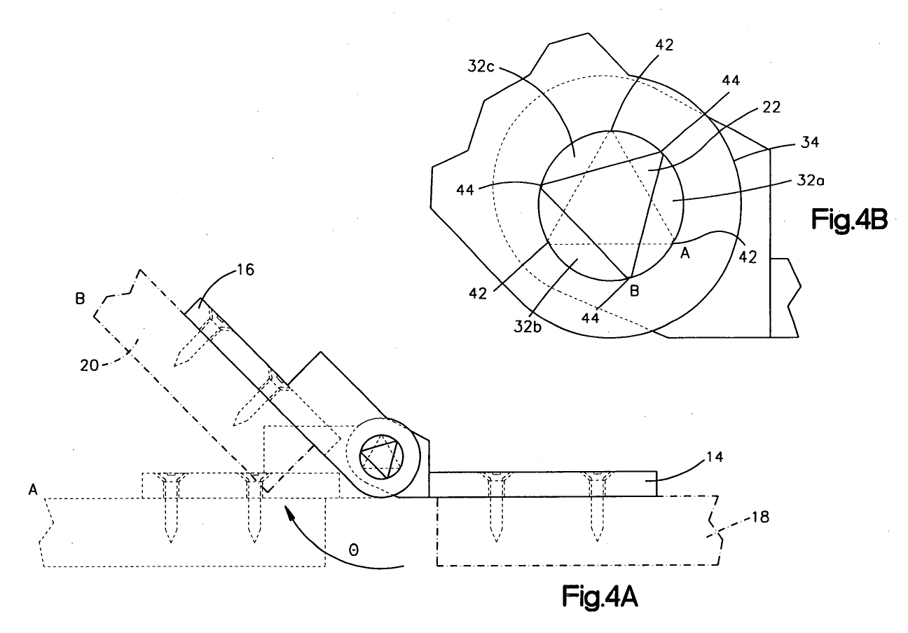

The hinge structure 12 comprises first 24 and second 26 triangular shaped hinge posts that are integrally molded within respective first and second cylindrical housings 28, 30. The triangular shaped hinge posts 24, 26 are journaled for rotation within the cylinder housings 28, 30, providing three points of substantially continuous contact with each respective cylindrical housing. The molding operation provides voids 32a, 32b, 32c between the triangular shaped hinge posts 24, 26 and the cylindrical housings 28, 30, as best seen in FIGS. 3, 4A and 4B.

The first and second cylindrical housings 28, 30 are formed within arms 34 and 36 that extend to a desired height from swivel member 16. It should be appreciated by those skilled in the art that the rotation of the swivel member 16 with respect to the base member 14, represented by Θ in FIG. 4A is capable of substantially 360 degrees.

Centrally located about the hinge structure 12 is a hub 38 having opposing first and second faces, 40a and 40b from which the first and second triangular shaped hinge posts 24, 26 fixedly extend. The hub 38 is attached to the base member 14. The base member 14 is coupled to the swivel member 16 through the hub 38, the triangular hinge posts 24, 26, and the arms 34, 36.

FIG. 4A illustrates the movement of the swivel element 16 about the base element 14 from a first position A to a second position B. Since the integrally molded hinge assembly 10 is molded as a single piece, initial rotation of the swivel element 12 with respect to the base element 14 breaks the molded connection between the triangular hinge posts 24, 26 and their respective cylinder housings 28 and 30 at break points 42, as illustrated in FIG. 4B. The initial rotation breaks the triangular hinge post connections just at the tips of the triangles such that subsequent rotation is freely obtained between the swivel and base elements (16, 14), allowing ends 44 of the triangular hinge posts 24, 26 to achieve substantially continuous three-point contact with the inner diameter of their respective cylindrical housings 28 and 30.

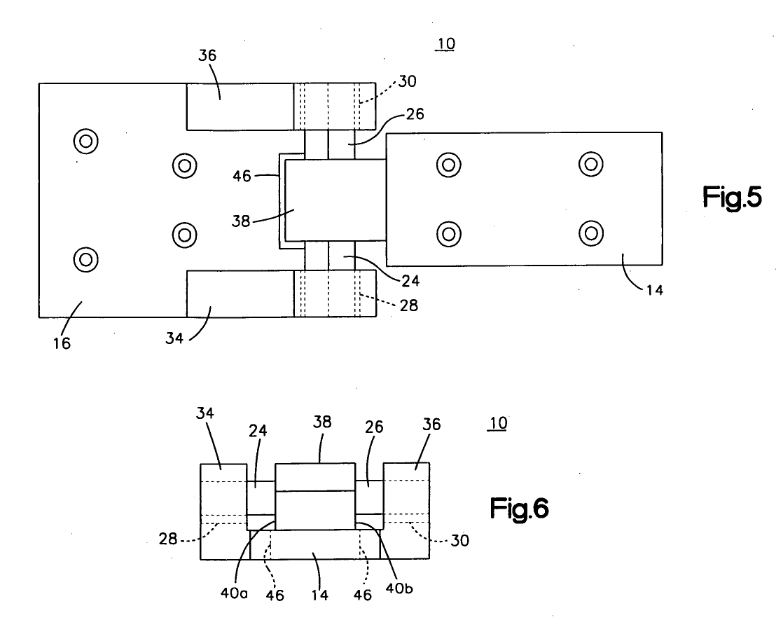

FIG. 5 illustrates a plan view of the integrally molded hinge assembly 10. As can be seen in FIG. 5, the swivel member 16 includes a relief area 46 in the form of a notch that would allow for rotation of the swivel member 16 with respect to the base member 14 without interfering or contacting the hub 38 during rotation. In an alternative example embodiment (not shown), the relief area 46 could extend laterally across the swivel member 16 between first 34 and second 36 arms. FIG. 6 illustrates an elevated end view of the integrally molded hinge assembly 10 of FIG. 5.

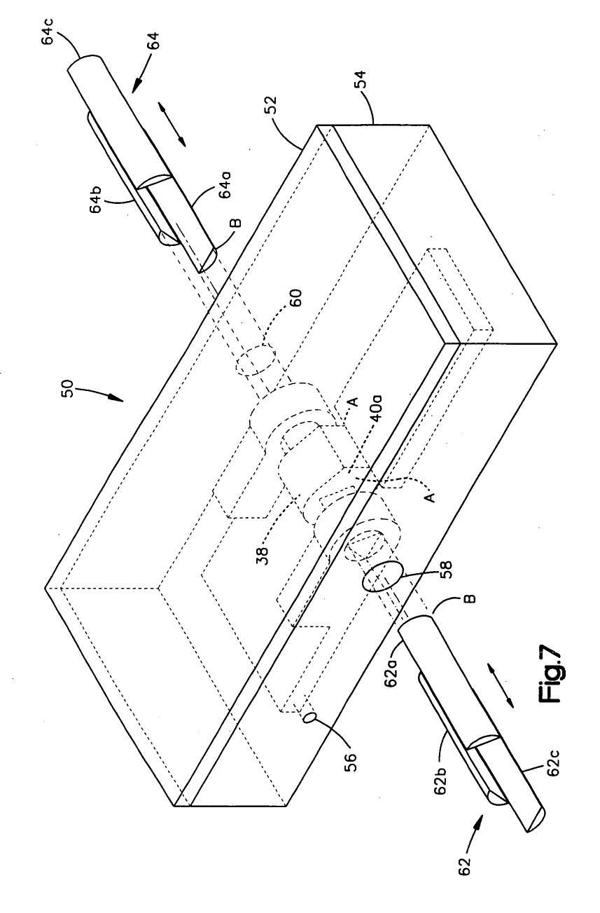

FIG. 7 is a schematic view of a method of molding the integrally molded hinge assembly 10 in accordance with one example embodiment of the present invention. The hinge structure 12, base element 14, and swivel element 16 are formed as one assembled unit during an in-mold assembly process, such as injection molding. The assembled unit of the hinge structure 12, base element 14, and swivel element 16 are molded into a single structure, eliminating the need for multiple parts and costly post-molding assembly processes. In addition to the reduced assembly costs, the integrally molded hinge assembly 10 eliminates quality issues, such as disassembly of the connecting hinge pieces, since disassembly is not possible without completely destroying the hinge. This eliminates the risks associated with conventional hinges that may become disassembled during operation, especially if exposed to an environment having a significant or a sustained amount of vibration.

In accordance with an example embodiment of the present invention, a molding assembly 50 includes an upper mold 52 and a lower mold 54. The upper 52 and lower 54 molds contain cavities for forming the components that make up the integrally molded hinge assembly 10, but are not shown for simplicity. Also for simplicity, sprues, gates, runners, and mold supports have been omitted. The molding assembly includes an injection molding station 56 for injecting the hinge assembly material into the mold cavities that define the integrally molded hinge assembly 10. It should be appreciated by those skilled in the art that the number of injection molding stations and their locations can vary without departing from the spirit and scope of the claimed invention.

Prior to injecting the material into the mold assembly 50, tooling comprising side action assemblies 62 and 64 is inserted through respective side apertures 58 and 60 of the mold assembly 50 until engaging internal stops located at positions A in FIG. 7 on the faces 40a and 40b of the hub 38. After the material is injected into the mold assembly 50 and cooled for a prescribed period of time, the side action assemblies 62, 64 are withdrawn from the mold assembly 50 as depicted in FIG. 7 to positions B. The removal of the side action assemblies 62, 64 produces the triangular shaped hinge posts 24, 26, cylindrical housings 28, 30, and the voids 32a, 32b, and 32c therebetween.

The side tool assemblies 62, 64 external constructions include a semi-circular geometrical configuration 62a, 62b, 62c, 64a, 64b, 64c, such that their interaction results in the cylindrical housing 28, 30 that provides a bearing surface for the triangular shaped hinge posts 24, 26. While the side tool assemblies internal constructions provide a planer surface 62a, 62b, 62c, 64a, 64b, 64c, such that their interaction results in the three-point triangular hinge posts 24, 26 leaving a prescribed integral connection with the housings that would allow separation upon initial rotation of the swivel member 16 about the base member 14. After the initial rotation, enough material remains at the ends 44 of the triangular shaped hinge posts 24, 26 to provide continuous contact with the cylindrical housings 28, 30.

The side tool assemblies 62a, 62b, 62c, 64a, 64b, 64c may be the same length and connected at the same point, but are illustrated in a staggered configuration for purposes of clarity in the molding process. After the side tool assemblies 62, 64 are removed, the upper 52 and lower 54 molds are separated, and the integrally molded hinge assembly 10 is ejected from the mold assembly 50, thereby completing the molding process.

From the above description of the invention, those skilled in the art will perceive improvements, changes and modifications. For example, it should be understood by those skilled in the art that the base element 14 is equally suitable for rotating about the swivel element 16 and that an unlimited number of surfaces could be represented by the first and second structures, 18 and 20, for attaching objects or closing plastic retainers, containers, covers and the like without departing from the spirit and scope of the claimed invention. Such improvements, changes and modifications within the skill of the art are intended to be covered by the appended claims.

Having described the invention, the following is claimed:

1. A hinge structure comprising:
a single molded swivel hinge molded initially as a unitary structure having a first portion and a second portion;
said first portion including first and second hinge pins extending in opposed directions from a base member; and
said second portion including hinge pin receiving portions, each said first and second hinge pins having an associated hinge pin receiving portion, each hinge pin receiving portion being molded to result in a cylindrical bore after initial operation of the hinge structure, each of said first and second hinge pins being triangular in shape over its extent within its associated hinge pin receiving portion.

2. The hinge structure of claim 1 wherein said first and second hinge pins remain in substantially continuous contact with said associated receiving portion.

3. The hinge structure of claim 1 wherein said first and second hinge pins are substantially equilateral triangles.

4. The hinge structure of claim 1 further comprising a hub member extending from said first portion projecting said first and second pins in opposing directions forming an integrally molded connection with said associated hinge pin receiving portions, such that initial rotation of the second portion with respect to said first portion fractures said integrally molded connection enabling a subsequently rotatable connection between said first and second portions.

5. The hinge structure of claim 1 wherein said hinge structure is formed from a thermal plastic material.

6. The hinge structure of claim 1 wherein said hinge structure is formed from a metal.

7. The hinge structure of claim 1 wherein said hinge structure is formed from a metal alloy.

8. The hinge structure of claim 1 wherein said second portion is capable of rotating substantially 360 degrees with respect to said first portion.

9. The hinge structure of claim 4 wherein said second portion is capable of rotating substantially 360 degrees with respect to said first portion.

10. A hinge assembly integrally molded from a single operation comprising:
a hinge member having at least one three-point triangular shaped pin integrally molded and fixedly extending from said hinge member the hinge member being made from a material; and
a swivel member having at least one cylindrical housing circumscribing and having an integrally molded connection with said three-point triangular shaped pin such that initial rotation of said swivel member with respect to said base member breaks said integrally molded connection providing a rotatable attachment between said cylindrical housing and said three-point triangular shaped pin, said swivel member being made from the same material as said hinge member during a single molding operation.

11. The hinge assembly of claim 10 wherein said triangular shaped three-point pin is an equilateral triangle.

12. The hinge assembly of claim 10 further comprising a hub member extending from said base member having first and second three-point triangular shaped pins projecting in opposing directions forming an integrally molded connection with a respective first and second cylindrical housing such that initial rotation of said swivel member with respect to said base member breaks said integrally molded connection providing a rotatable attachment between said cylindrical housings and said three-point triangular shaped pins.

13. The hinge assembly of claim 12 wherein said first and second three-point triangular pins are in substantially continuous contact with said first and second cylindrical housings.

14. The hinge assembly of claim 10 wherein said molded connection provides semi-circular voids between said three-point triangular shaped pin and said cylindrical housing.

15. A method of making an integrally molded hinge assembly comprising the steps of:
providing a mold having cavities for forming an integrally molded hinge assembly having a base member and a swivel member;
inserting a first and a second set of side tooling into said mold to a prescribed distance;
injecting material into said mold through at least one port, filling said cavities with said material;
forming an integral connection between said base member and said swivel member; and
withdrawing said side tooling from said mold creating voids between said base member and said swivel member to enable relative movement therebetween.

16. The method of claim 15 wherein said step of forming an integral connection comprises forming a three-point integral connection between said swivel member and said base member.

17. The method of claim 15 further comprising the step of rotating said swivel member about said base member such that the initial rotation breaks said integral connection allowing free rotation between the base and swivel members.

18. The method of claim 16 further comprising the step of rotating said swivel member about said base member such that the initial rotation breaks said three-point integral connection allowing free rotation between the base and swivel members.

19. The method of claim 15 wherein said step of forming an integral connection comprises forming a first and a second three-point integral connection between said swivel member and said base member.

20. The method of claim 19 further comprising the step of rotating said swivel member about said base member such that the initial rotation breaks said first and second three-point integral connections allowing free rotation between the base and swivel members.
